(19) United States
(12) Patent Application Publication
(10) Pub. No.: US 2024/0028813 A1
(43) Pub. Date: Jan. 25, 2024

(54) SEMICONDUCTOR LAYOUT AND METHOD FOR CHECKING THE SHIFT IN THE SEMICONDUCTOR LAYOUT

(71) Applicant: Vanguard International Semiconductor Corporation, Hsinchu (TW)

(72) Inventors: Yeh-Ning JOU, Hsinchu City (TW); Chih-Hsuan LIN, Hsinchu City (TW); Shu-Pin HSU, Zhubei City (TW); Hwa-Chyi CHIOU, Hsinchu City (TW); Chang-Min LIN, Taichung City (TW); Tsong-Shyan CHEN, Hsinchu City (TW)

(73) Assignee: Vanguard International Semiconductor Corporation, Hsinchu (TW)

(21) Appl. No.: 17/872,858

(22) Filed: Jul. 25, 2022

(51) Int. Cl. G06F 30/398

(52) U.S. Cl. CPC G06F 30/398

(57) ABSTRACT

A semiconductor layout including a semiconductor layer and a dummy layer is provided. The semiconductor layer includes a layout pattern. The dummy layer includes a dummy pattern. A check circuit calculates the layout pattern and the dummy pattern to generate a calculated value. The check circuit compares the calculated value to the predetermined value to determine whether the layout pattern has been modified.

### BACKGROUND OF THE INVENTION

### Field of the Invention

The invention relates to a semiconductor layout, and more particularly to a semiconductor layout that comprises a dummy pattern which is used determined whether the semiconductor layout has been modified.

### Description of the Related Art

Semiconductor processes for forming integrated circuits require a set of process steps that include both precipitation steps and forming steps. This forms patterns in isolation layers, polysilicon layers, and metal layers. However, whenever the pattern of a certain semiconductor layer has been modified, the integrated circuit cannot work normally.

### BRIEF SUMMARY OF THE INVENTION

In accordance with an embodiment of the disclosure, a semiconductor layout comprises a semiconductor layer and a dummy layer. The semiconductor layer comprises a layout pattern. The dummy layer comprises a dummy pattern. A check circuit calculates the layout pattern and the dummy pattern to generate a calculated value and compares the calculated value and a predetermined value to determine whether the layout pattern has been modified.

In accordance with another embodiment of the disclosure, a method for checking a semiconductor layout, comprises forming a first layout pattern in a first semiconductor layer; forming a first dummy pattern in a first dummy layer; performing a Boolean operation to calculate the first layout pattern and the first dummy pattern to generate a first calculated value; and comparing the first calculated value and a first predetermined value. In response to the first calculated value not being equal to the first predetermined value, it is determined that the first layout pattern has been modified.

Check methods of a semiconductor layout may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a check circuit for practicing the disclosed method.

### BRIEF DESCRIPTION OF THE DRAWINGS

The invention can be more fully understood by referring to the following detailed description and examples with references made to the accompanying drawings, wherein:

FIGS. 1A-1D are schematic diagrams of exemplary embodiments of a semiconductor layout according to various aspects of the present disclosure.

FIGS. 2A and 2B are overlapping schematic diagrams of exemplary embodiments of a layout pattern and a dummy pattern according to various aspects of the present disclosure.

FIGS. 3A and 3B are overlapping schematic diagrams of exemplary embodiments of the layout pattern and another dummy pattern according to various aspects of the present disclosure.

FIGS. 4A and 4B are overlapping schematic diagrams of exemplary embodiments of the layout pattern and another dummy pattern according to various aspects of the present disclosure.

FIGS. 5A and 5B are overlapping schematic diagrams of exemplary embodiments of the layout pattern and another dummy pattern according to various aspects of the present disclosure.

FIGS. 6A and 6B are overlapping schematic diagrams of exemplary embodiments of the layout pattern and another dummy pattern according to various aspects of the present disclosure.

FIGS. 7A and 7B are overlapping schematic diagrams of exemplary embodiments of the layout pattern and another dummy pattern according to various aspects of the present disclosure.

FIGS. 8A and 8B are overlapping schematic diagrams of exemplary embodiments of the layout pattern and two dummy patterns according to various aspects of the present disclosure.

FIG. 9 is an overlapping schematic diagram of other exemplary embodiments of a layout pattern and a dummy pattern according to various aspects of the present disclosure.

FIG. 10 is a flowchart of an exemplary embodiment of a method for checking a semiconductor layout.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

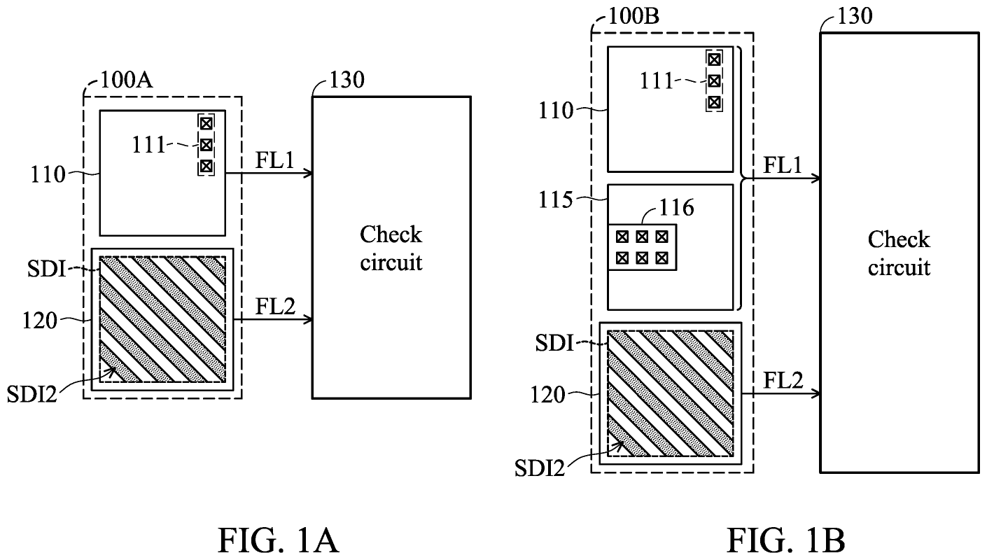

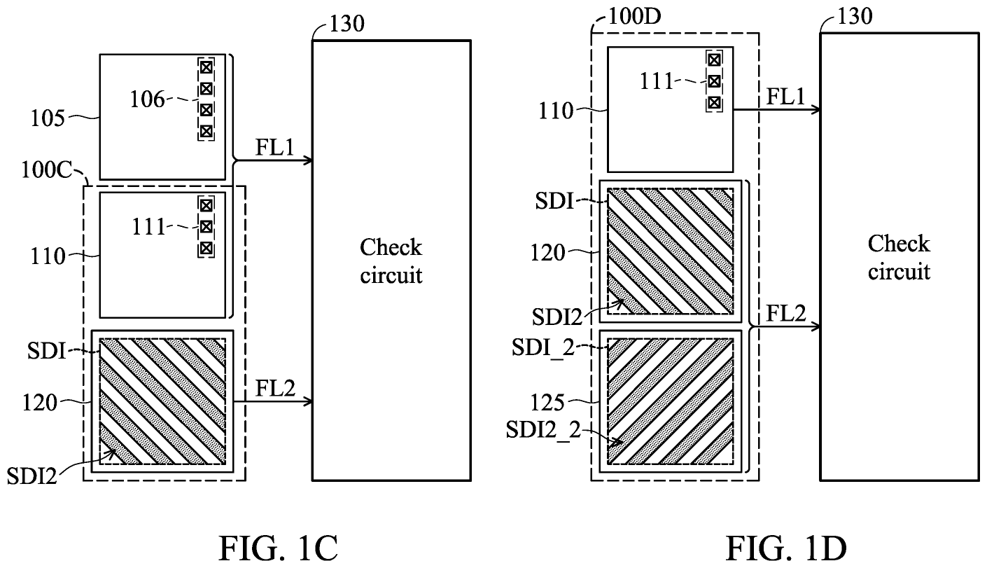

FIG. 1A is a schematic diagram of an exemplary embodiment of a semiconductor layout according to various aspects of the present disclosure. The semiconductor layout 100A comprises a semiconductor layer 110 and a dummy layer 120. The semiconductor layer 110 comprises a layout pattern 111. In this embodiment, the layout pattern 111 comprises three contacts, but the disclosure is not limited thereto. The type of layout pattern 111 is not limited in the present disclosure. In some embodiments, the semiconductor layer 110 is a semiconductor layer which comprises one of a combination of wells, oxide diffusion regions, poly regions, vias, metals. In such cases, the layout pattern 111 may be an N-type well, a P-type well, a diffusion region, a poly region, a via, or a metal.

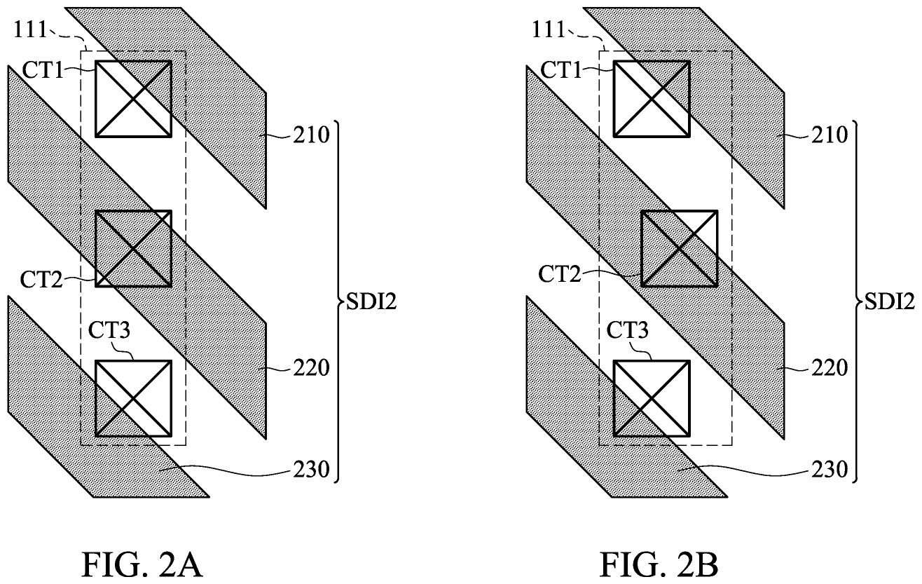

The dummy layer 120 comprises a dummy pattern SID 2. In this embodiment, the dummy pattern SDI2 comprises a plurality of line segments. In this case, the line segments are arranged in parallel to each other. In other embodiments, the dummy pattern SDI2 is similar to a pattern of a two-dimensional code, such as a QR code, but the disclosure is not limited thereto. The shape of dummy pattern SDI2 is not limited in the present disclosure. The shape of the dummy pattern SDI 2 is shown in FIGS. 2A, 3A, 4A, 5A, 6A, and 7A. In other embodiments, the dummy layer 120 further comprises a dummy pattern SDI. The shape of the dummy pattern SDI is a rectangle shape which surrounds the dummy pattern SDI2.

In one embodiment, a check circuit 130 calculates the layout pattern 111 and the dummy pattern SDI2 to generate a calculated value. In one embedment, the calculated value is a pattern density value. In this case, the pattern density value is related to the measure of overlapping area between the layout pattern 111 and the dummy pattern SDI2. The check circuit 130 compares the calculated value and a predetermined value to determine whether the layout pattern 111 has been modified. It is determined that the layout pattern 111 is shifted, the shape of the layout pattern 111 is changed, the area of the layout pattern 111 is increased or reduced. When the calculated value is equal to the predetermined value, the check circuit 130 determines that the layout pattern 111 has not been modified. However, when the calculated value is not equal to the predetermined value, the check circuit 130 determines that the layout pattern 111 has been modified. In one embodiment, the check circuit 130 highlights and records the layout pattern 111.

After all semiconductor layers are tested, the check circuit 130 provides a test report. The tester determines whether the layout pattern 111 in the semiconductor layer 110 has been modified according to the test report. The test report may be a design rule checker (DRC) report.

In this embodiment, the check circuit 130 receives the electronic files FL1 and FL2. The electronic file FL1 records the characteristics of the layout pattern 111, such as the position of the layout pattern 111 and the area of the layout pattern 111. The electronic file FL2 records the characteristics of the dummy pattern SDI2, such as the position of the dummy pattern SDI2 and the area of the dummy pattern SDI2. In one embodiment, the electronic files FL1 and FL2 may be two-dimensional vector files, such as a Gerber file.

In some embodiments, the semiconductor layout 100A and the check circuit 130 constitute a test system. The check circuit 130 is configured to check whether the layout pattern of the semiconductor layout 100A has been modified. When the semiconductor layout 100A comprises many semiconductor layers, the check circuit 130 compares the layout pattern of each semiconductor layer and at least one dummy pattern to generate a plurality compared results. The check circuit 130 compares each compared result and a corresponding predetermined value to determine whether the corresponding layout pattern has been modified. In one embodiment, the check circuit 130 determines whether the corresponding layout pattern is shifted, the area of the corresponding layout pattern is increased or reduced.

FIG. 1B is a schematic diagram of another exemplary embodiment of the semiconductor layout according to various aspects of the present disclosure. FIG. 1B is similar to FIG. TA except for the addition of a semiconductor layer 115. The number of semiconductor layers is not limited in the present disclosure. In other embodiments, the semiconductor layout 100B comprises more semiconductor layers.

The semiconductor layer 115 comprises a layout pattern 116. In one embodiment, the layout pattern 116 is a pattern of a N-type well. In this case, the semiconductor layers 110 and 115 are combined into the same element layout. The electronic file FL1 records the physical characteristics of the layout patterns 111 and 116.

In this embodiment, the check circuit 130 calculates the layout pattern 111 and the to generate a first calculated value and compares the first calculated value and a first predetermined value. The check circuit 130 determines whether the layout pattern 111 has been modified according to the compared result between the first calculated value and the first predetermined value. In this case, the check circuit 130 further calculates the layout pattern 116 and the dummy pattern SDI2 to generate a second calculated value and compares the second calculated value to the second predetermined value. The check circuit 130 determines whether the layout pattern 116 has been modified according to the compared result between the second calculated value and the second predetermined value.

FIG. 1C is a schematic diagram of another exemplary embodiment of the semiconductor layout according to various aspects of the present disclosure. FIG. 1C is similar to FIG. 1A exception that the check circuit 130 of FIG. 1C further calculates the layout pattern 106 and the dummy pattern SDI2 to generate a second calculated value. In one embodiment, the layout pattern 106 is the previous edition of the layout pattern 111 or the next edition of the layout pattern 111. In such cases, the check circuit 130 determines the difference between the layout patterns 106 and 111 according to the first and second calculated values. For example, if the first calculated value is different from the second calculated value, the check circuit 130 determines that there is a difference between the layout patterns 106 and 111. The check circuit 130 records and highlights the difference. In this case, the semiconductor layers 105 and 110 does not be combined into the same semiconductor layout. If the first calculated value is the same as the second calculated value, the check circuit 130 determines that the layout pattern 106 is the same as the layout pattern 111.

FIG. 1D is a schematic diagram of another exemplary embodiment of the semiconductor layout according to various aspects of the present disclosure. FIG. 1D is similar to FIG. 1A except for the addition of a dummy layer 125. The number of dummy layer is not limited in the present disclosure. The semiconductor layout may comprise more dummy layers.

The dummy layer 125 comprises a dummy pattern SDI2_2. The dummy pattern SDI2_2 comprises a plurality of line segments. In such cases, the line segments are arranged in parallel to each other and regularly disposed in the dummy layer 125. In this embodiment, the shape of the dummy pattern SDI2_2 in the dummy layer 125 is different from the shape of the dummy pattern SDI2 in the dummy layer 120. In some embodiments, the shape of the dummy pattern SDI2 may be similar to the shape of the dummy pattern SDI2_2, such as diagonal segments from upper left to lower right, but the widths of the line segments of the dummy pattern SDI2 may be different from the widths of the ling segments of the dummy pattern SDI2_2.

In other embodiments, the dummy layer 125 further comprises a dummy pattern SDI_2. The dummy pattern SDI_2 is a rectangle shape and surrounds the dummy pattern SDI2_2. In this case, the dummy pattern SDI_2 in the dummy layer 125 is similar to the dummy pattern SDI in the dummy layer 120.

In one embodiment, the check circuit 130 calculates the layout pattern 111 and the dummy pattern SDI2 to generate a first calculated value and compares the first calculated value and a first predetermined value. When the first calculated value is equal to the first predetermined value, the check circuit 130 calculates the layout pattern 111 and the dummy pattern SDI2_2 to generate a second calculated value and compares the second calculated value to the second predetermined value. When the second calculated value is not equal to the second predetermined value, the check circuit 130 determines that the layout pattern 111 has been modified.

FIGS. 2A and 2B are overlapping schematic diagrams of exemplary embodiments of the layout pattern 111 and the dummy pattern SDI2 according to various aspects of the present disclosure. The layout pattern 111 comprises contacts CT1˜CT3. The dummy pattern SDI2 comprises patterns 210˜230. In one embodiment, the check circuit 130 determines whether the contacts CT1˜CT3 have been modified according to the overlapping area between the contacts CT1˜CT3 and the patterns 210˜230. For example, one of the contacts CT1˜CT3 is shifted or the size of one of the patterns 210˜230 is changed.

For example, in FIG. 2A, the check circuit 130 calculates the overlapping area (referred to as first area) between the contact CT1 and the pattern 210, the overlapping area (referred to as second area) between the contact CT2 and the pattern 220, and the overlapping area (referred to as third area) between the contact CT3 and the pattern 230. In this case, the check circuit 130 calculates the sum of the first area, the second area, and the third area to generate a first calculated result (referred to as a calculated value). The check circuit 130 determines whether the first calculated result is equal to a predetermined value. In FIG. 2A, since the layout pattern 111 has not been modified, the first calculated result is equal to the predetermined value.

However, in FIG. 2B, the layout pattern 111 is shifted. For example, the contact CT2 is shifted to the right. In this case, the overlapping area between the contact CT2 and the pattern 220 in FIG. 2B is less than the overlapping area between the contact CT2 and the pattern 220 in FIG. 2A. Therefore, the calculated value generated by the check circuit 130 is not equal to the predetermined value.

In other embodiments, the check circuit 130 may compare the overlapping area (referred to as first area) between the contact CT1 and the pattern 210 and a first value, the overlapping area (referred to as second area) between the contact CT2 and the pattern 220 and a second value, and the overlapping area (referred to as third area) between the contact CT3 and the pattern 230 and a third value to determine whether anyone of the contacts CT1˜CT3 is shifted. For example, when the second area is not equal to the second value, the check circuit 130 determines that the contact CT2 has been shifted or the size of the contact CT2 has been changed. Therefore, the check circuit 130 highlights the contact CT2 in the test report.

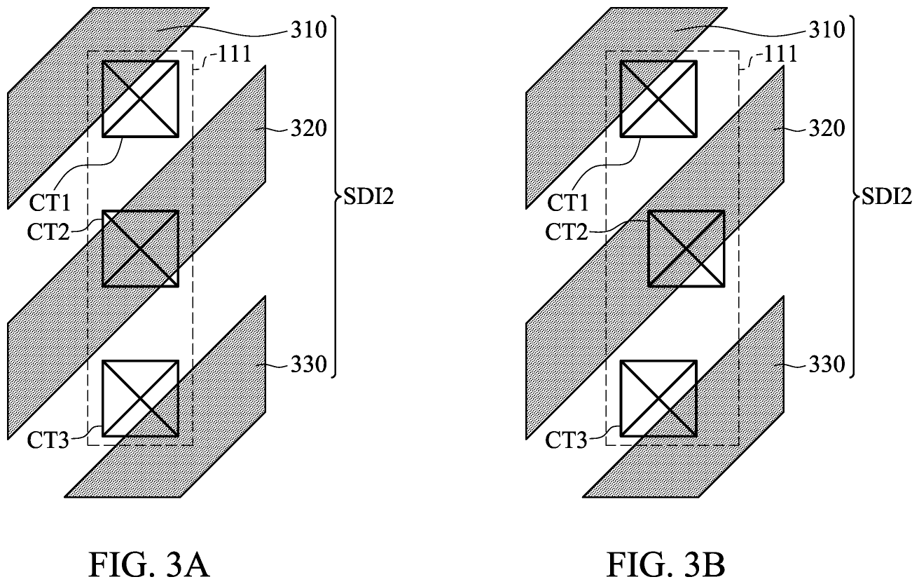

FIGS. 3A and 3B are overlapping schematic diagrams of other exemplary embodiments of the layout pattern 111 and the dummy pattern SDI2 according to various aspects of the present disclosure. FIG. 3A is similar to FIG. 2A except for the shape of the dummy pattern SDI2. In FIG. 2A, the shape of the dummy pattern SDI2 has the diagonal segments from upper left to lower right. In FIGS. 3A and 3B, the shape of the dummy pattern SDI2 has diagonal segments from lower left to upper right.

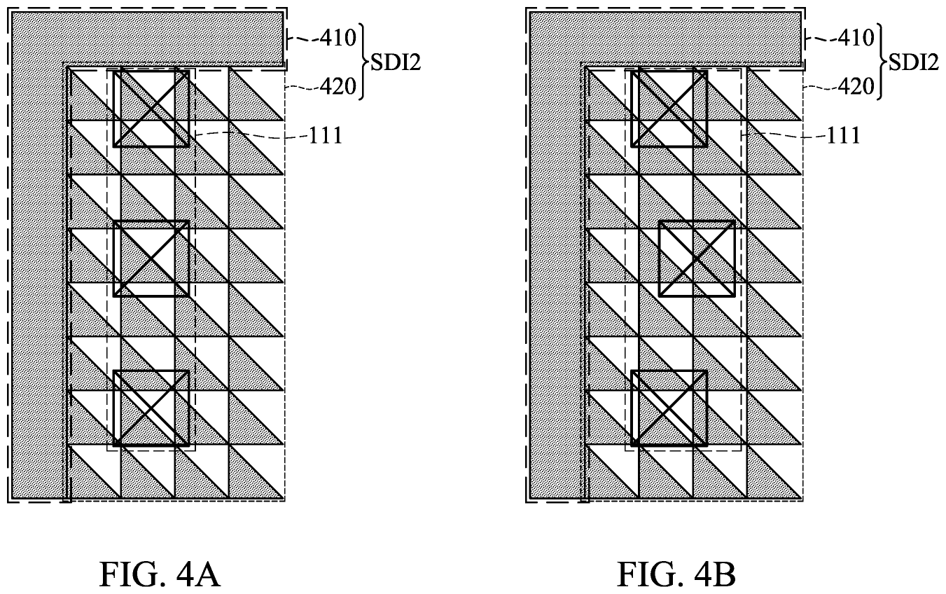

FIGS. 4A and 4B are overlapping schematic diagrams of other exemplary embodiments of the layout pattern 111 and the dummy pattern SDI2 according to various aspects of the present disclosure. FIG. 4A is similar to FIG. 2A except for the shape of the dummy pattern SDI2. In this embodiment, the dummy pattern SDI2 comprises patterns 410 and 420. The shape of the pattern 410 is different from the shape of the pattern 420. The pattern 420 is constituted by a plurality of triangular patterns.

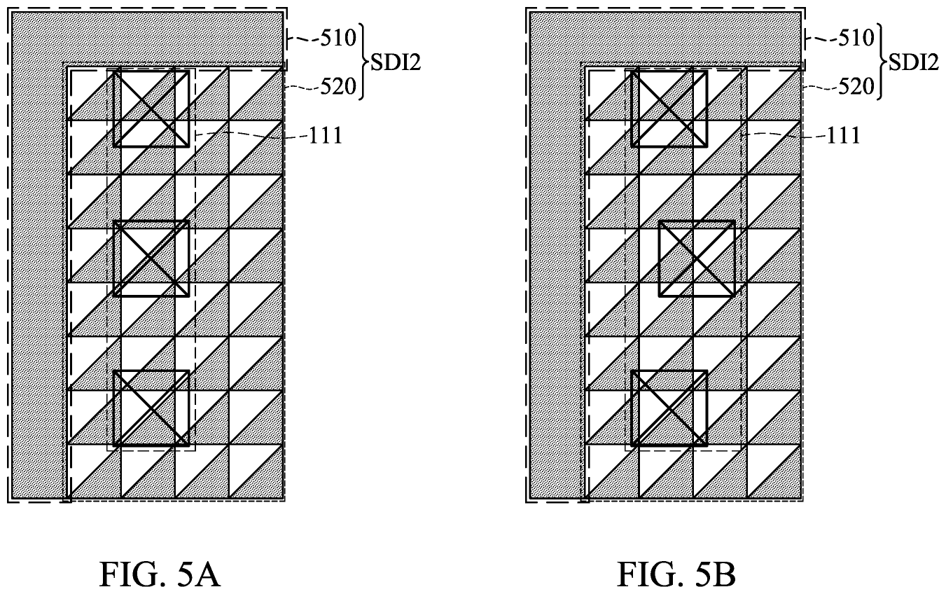

FIGS. 5A and 5B are overlapping schematic diagrams of other exemplary embodiments of the layout pattern 111 and the dummy pattern SDI2 according to various aspects of the present disclosure. FIG. 5A is similar to FIG. 4A except for the shape of the dummy pattern SDI2. In FIG. 5A, the hypotenuses of the triangular patters are toward the left. In FIG. 4A, the hypotenuses of the triangular patterns are toward the right.

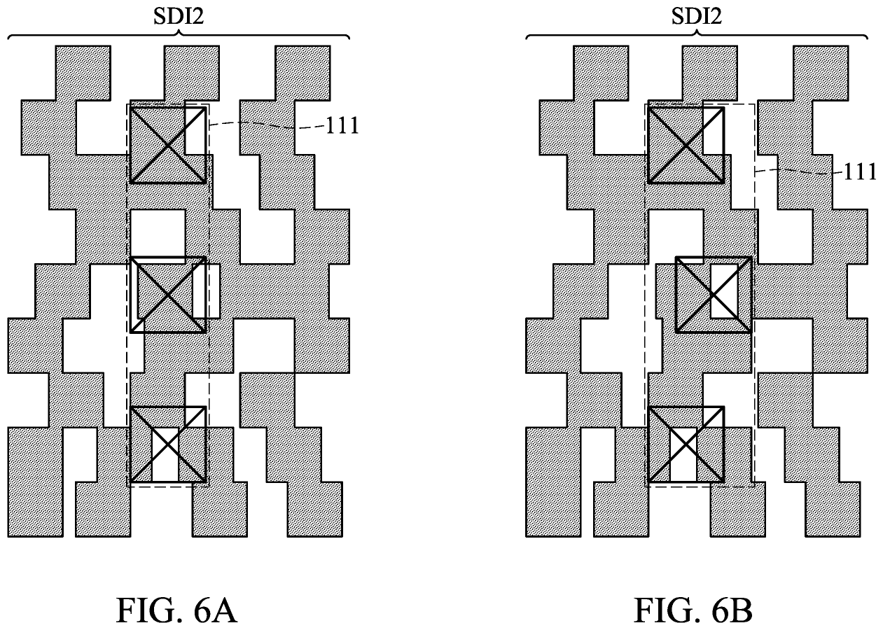

FIGS. 6A and 6B are overlapping schematic diagrams of other exemplary embodiments of the layout pattern 111 and the dummy pattern SID2 according to various aspects of the present disclosure. In this embodiment, the dummy pattern SDI2 comprises a plurality of rectangular patterns. The area of one of the rectangular patterns is different from the area of another of the rectangular patterns.

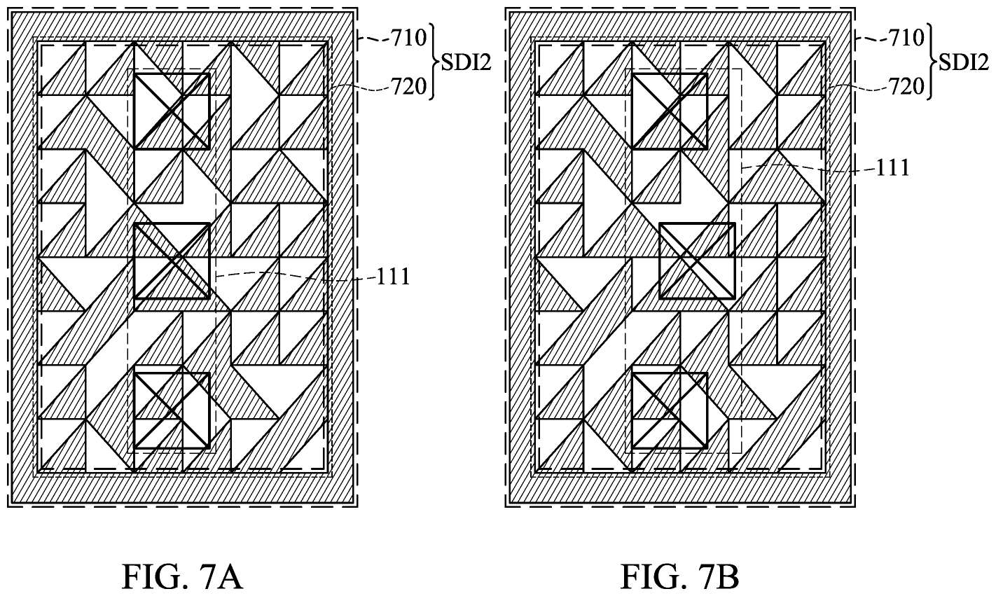

FIGS. 7A and 7B are overlapping schematic diagrams of another exemplary embodiment of the layout pattern 111 and the dummy pattern SDI2 according to various aspects of the present disclosure. The dummy pattern SDI2 comprises patterns 710 and 720. The shape of the pattern 710 is a rectangle shape and surrounds the pattern 720. In this embodiment, the pattern 720 comprises a plurality of patterns which are arranged in irregularity. The shapes of the patterns included in the pattern 720 comprise a plurality of triangle shapes and a plurality of triangle shapes.

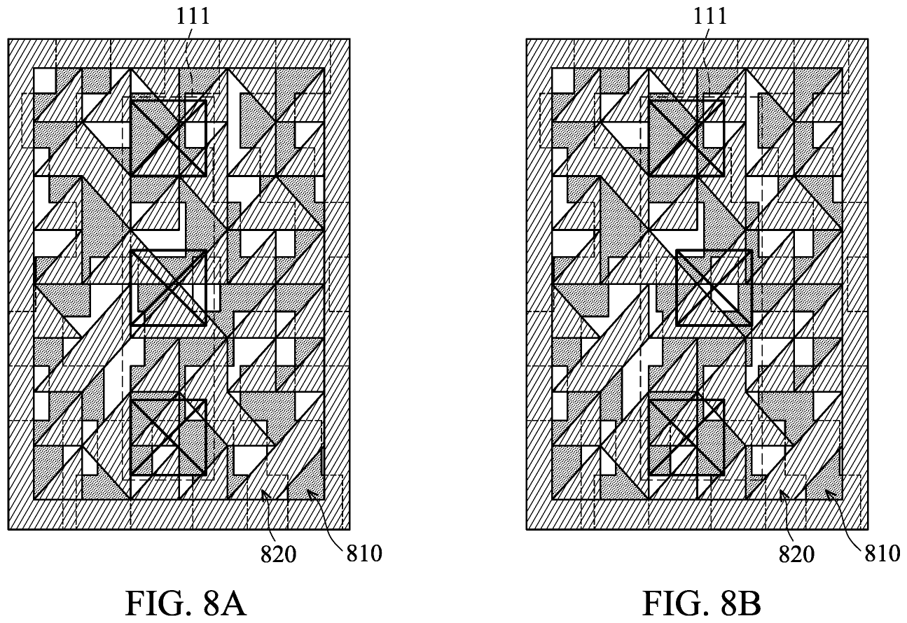

FIGS. 8A and 8B are overlapping schematic diagrams of exemplary embodiments of the layout pattern 111 and two dummy patterns according to various aspects of the present disclosure. In this embodiment, the dummy pattern 810 in FIG. 8A is similar to the dummy pattern SDI2 in FIG. 6A, and the dummy pattern 820 in FIG. 8A is similar to the dummy pattern SDI2 in FIG. 7A. The dummy patterns 810 and 820 are disposed in different dummy layers. In such cases, the dummy layer including the dummy pattern 810 is disposed below the dummy layer including the dummy pattern 820. In other embodiments, the semiconductor layer including the layout pattern 111 is disposed between the dummy layer including the dummy pattern 810 and the dummy layer including the dummy pattern 820.

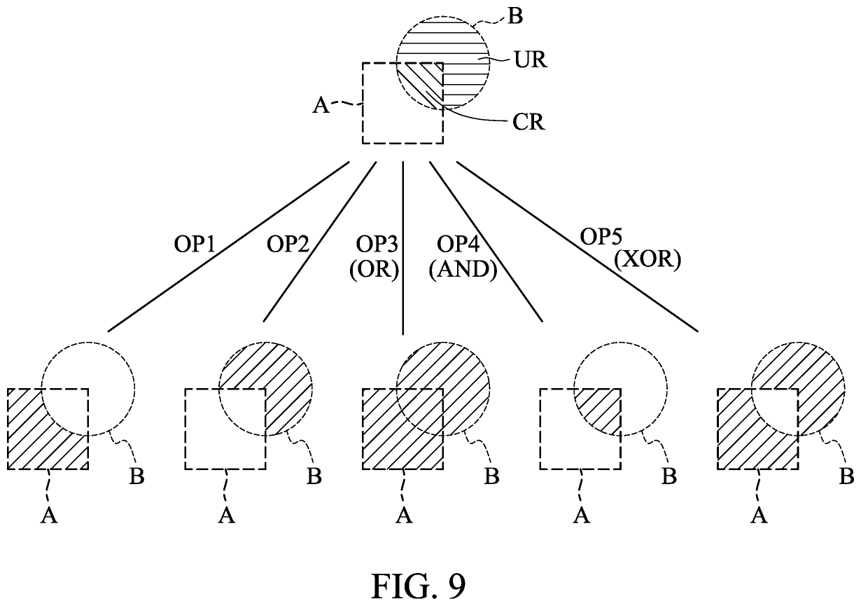

FIG. 9 is an overlapping schematic diagram of other exemplary embodiments of a layout pattern and a dummy pattern according to various aspects of the present disclosure. To brevity, FIG. 9 only shows a single layout pattern B and a single dummy pattern A. The shapes of the dummy pattern A and the layout pattern B are not limited in the present disclosure. In this embodiment, the shape of the dummy pattern A is a rectangular shape, and the shape of the layout pattern B is a circular shape. In this case, the layout pattern B comprises parts UR and CR. The part UR does not overlap the dummy pattern A. The part CR overlaps the dummy pattern A.

In one embodiment, the check circuit 130 performs a Boolean operation OP1 to calculate the dummy pattern A and the layout pattern B to generate a first calculated value. In this case, the check circuit 130 calculates the difference between the area of the dummy pattern A and the area of the part CR and uses the difference as the first calculated value. In other embodiments, the check circuit 130 may subtract the area of the part CR from the area of the dummy pattern A and uses the subtraction result as a calculated value.

In another embodiment, the check circuit 130 performs another Boolean operation OP2 to calculate the dummy pattern A and the layout pattern B to generate a second calculated value. In this case, the second calculated value is the difference between the area of the layout pattern B and the area of the part CR.

In some embodiment, the check circuit 130 uses another Boolean operation OP3 to calculate the dummy pattern A and the layout pattern B to generate a third calculated value. In this case, the third calculated value is the sum of the area of the dummy pattern A and the area of the part UR of the layout pattern B. In this case, the Boolean operation OP3 is an OR operation.

In another embodiment, the check circuit 130 uses another Boolean operation OP4 to calculate the dummy pattern A and the layout pattern B to generate a fourth calculated value. In this case, the fourth calculated value is the area of the part CR of the layout pattern B. In this case, the Boolean operation OP4 is a AND operation.

In other embodiments, the check circuit 130 performs another Boolean operation OP5 to calculate the dummy pattern A and the layout pattern B to generate a fifth calculated value. In this case, the check circuit 130 calculates the difference between the area of the dummy pattern A and the area of the part CR and then adds the difference to the area of the part UR. In this embodiment, the Boolean operation OP5 is a XOR operation.

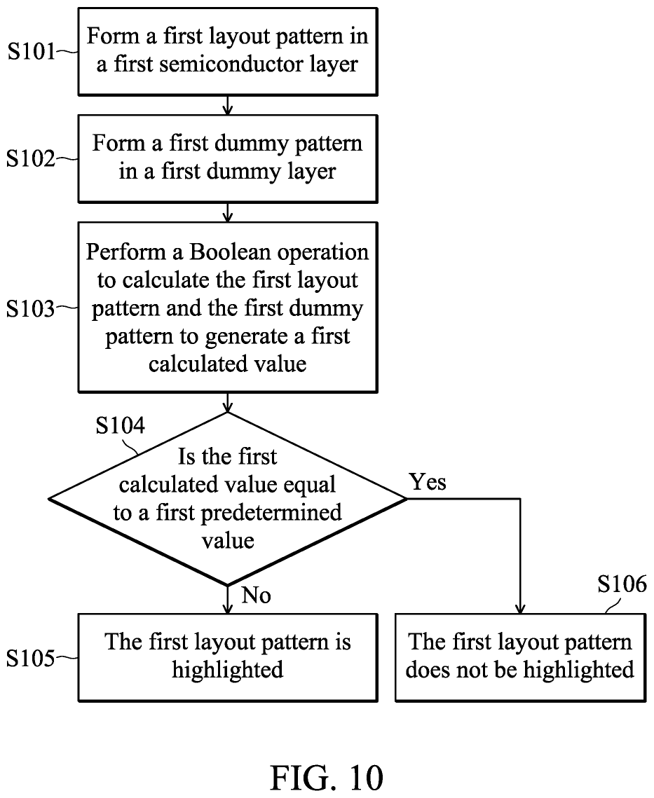

FIG. 10 is a flowchart of an exemplary embodiment of a method for checking a semiconductor layout. First, a first layout pattern is formed in a first semiconductor layer (step S101). The kind of first layout pattern is not limited in the present disclosure. In one embodiment, the first layout pattern may be used to form a layout pattern of a well, an oxide diffusion (OD), a poly layer, a via, or a metal.

Then, a first dummy pattern is formed in a first dummy layer (step S102). The shape of the first dummy pattern is not limited in the present disclosure. The first dummy pattern may be a specific irregularity pattern. In one embodiment, the first dummy pattern is similar to a pattern of a two-dimensional code.

A Boolean operation is performed to calculate the first layout pattern and the first dummy pattern to generate a first calculated value (step S103). In one embodiment, the Boolean operation is one or a combination of a AND operation, an OR operation, and a XOR operation. In some embodiments, S103 is to generate a first calculated value according to the overlapping area between the first layout pattern and the first dummy pattern. Taking FIG. 9 as an example, the first calculated value may be a calculated result that the overlapping area (i.e., the area of the part CR) of the layout pattern B (referred to as a first layout pattern) and the dummy pattern A (referred to as a first dummy pattern) is subtracted from the area of the dummy pattern A. In other embodiment, the first calculated value is a calculated result that the overlapping area (i.e., the area of the part CR) of the layout pattern B (referred to as a first layout pattern) and the dummy pattern A (referred to as a first dummy pattern) is subtracted from the area of the layout pattern B. In some embodiments, the first calculated value may be a calculated result that the overlapping area (i.e., the area of the part CR) of the layout pattern B (referred to as a first layout pattern) and the dummy pattern A (referred to as a first dummy pattern) is subtracted from the sum of the area of the dummy pattern A and the area of the layout pattern B. In other embodiments, the first calculated value may be the overlapping area (i.e., the area of the part CR) of the layout pattern B (referred to as a first layout pattern) and the dummy pattern A (referred to as a first dummy pattern). In some embodiments, the overlapping area (i.e., the area of the part CR) of the layout pattern B (referred to as a first layout pattern) and the dummy pattern A (referred to as a first dummy pattern) is subtracted from the area of the dummy pattern A to generate a first calculated result and then the first calculated result is added to the area of the part UR to generate a second calculated result. In this case, the second calculated result serves as the first calculated value.

Then, a determination is made as to whether the first calculated value is equal to a first predetermined value (step S104). When the first calculated value is not equal to the first predetermined value, it is determined that the first layout pattern has been modified. Therefore, the first layout pattern is highlighted (step S105). In some embodiments, step S105 is to record the first layout pattern. The user knows the modified semiconductor layer according to the recorded result of step S105. However, when the first calculated value is equal to the first predetermined value, it is determined that the first layout pattern has not been modified. Therefore, the first layout pattern does not be highlighted (step S106).

In some embodiments, step S102 is to form a second dummy pattern in a second dummy layer. The second dummy pattern may be the same as or different from the first dummy pattern. In one embodiment, a little difference occurs between the first and second dummy patterns, such as the size of the line segments or the distance between the line segments. Step S103 is further to perform the same Boolean operation to calculate the first layout pattern and the second dummy pattern to generate a second calculated value. In other embodiments, step S103 may be to perform another Boolean operation to calculate the first layout pattern and the second dummy pattern to generate a second calculated value. In this case, when the first calculated value is the same as the first predetermined value, the first layout pattern does not be highlighted temporarily in step S106. The second calculated value is compared with a second predetermined value. When the second calculated value is different from the second predetermined value, it is determined that the first layout pattern has been modified. Therefore, step S105 is performed to highlight the first layout pattern.

In one embodiment, step S101 is further to form a second layout pattern in a second semiconductor layer. In this case, step S103 is to perform the same Boolean operation to calculate the second layout pattern and the first dummy pattern to generate a third calculated value. In another embodiment, step S103 is to perform another Boolean operation to calculate the second layout pattern and the first dummy pattern to generate a second calculated value. In this case, step S104 is further to compare the third calculated value to the third predetermined value to determine whether the second layout pattern has been modified. When the third calculated value is different from the third predetermined value, it is determined that the second layout pattern has been modified. Therefore, step S105 is to highlight the second layout pattern.

In other embodiments, step S103 is further to perform the same Boolean operation to calculate a second layout pattern and the first dummy pattern to generate a second calculated value. In this case, step S104 is to compare each of the first and third calculated values with the first predetermined value. When the first and third calculated values are the same as the first predetermined value, it is determined that the first layout pattern is the same as the second layout pattern. When the first or third calculated value is different from the first predetermined value, it is determined that there is a difference between the first and second layout patterns. Therefore, step S105 is to record the corresponding semiconductor layer having the difference and to output a test result which records the semiconductor layer having the difference. In this case, the second layout pattern is in a second semiconductor layer which is not integrated with the first semiconductor layer in the same chip.

It will be understood that when an element or layer is referred to as being “connected to” or “coupled to” another element or layer, it can be directly on, connected or coupled to the other element or layer or intervening elements or layers may be present. In contrast, when an element or layer is referred to as be “directly connected to” or “directly coupled to” another element or layer, there are no intervening elements or layers present.

Check methods of a semiconductor layout may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a check circuit for practicing the check methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a check circuit for practicing the disclosed methods. When implemented on a general-purpose processor, the program code combines with the processor to provide a unique apparatus that operates analogously to application-specific logic circuits.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A semiconductor layout comprising:
a first semiconductor layer comprising a first layout pattern; and
a first dummy layer comprising a first dummy pattern,
wherein a check circuit calculates the first layout pattern and the first dummy pattern to generate a first calculated value and compares the first calculated value and a first predetermined value to determine whether the first layout pattern has been modified.

2. The semiconductor layout as claimed in claim 1, wherein in response to the first calculated value not being equal to the first predetermined value, the check circuit records the location of the first layout pattern.

3. The semiconductor layout as claimed in claim 1, wherein the first calculated value is an overlapping area between the first layout pattern and the first dummy pattern.

4. The semiconductor layout as claimed in claim 1, wherein the first layout pattern comprises:
a first part overlapping a portion of the first dummy pattern; and
a second part, which does not overlap the first dummy pattern,
wherein the first calculated value is a sum of the area of the first dummy pattern and the area of the second part.

5. The semiconductor layout as claimed in claim 1, wherein the first layout pattern comprises:
a first part overlapping a portion of the first dummy pattern; and
a second part, which does not overlap the first dummy pattern,
wherein the check circuit calculates a sum of the area of the first dummy pattern and the area of the second part and then calculates a difference between the sum and the area of first part, and the difference is used as the first calculated value.

6. The semiconductor layout as claimed in claim 1, wherein the first dummy pattern is a pattern of a two-dimensional code.

7. The semiconductor layout as claimed in claim 1, further comprising:
a second dummy pattern,
wherein:
the check circuit calculates the first layout pattern and the second dummy pattern to generate a second calculated value and compares the second calculated value to a second predetermined value, and
in response to the first calculated value being equal to the first predetermined value and the second calculated value not being equal to the second predetermined value, the check circuit determines that the first layout pattern has been modified.

8. The semiconductor layout as claimed in claim 7, wherein the first dummy pattern is different from the second dummy pattern.

9. The semiconductor layout as claimed in claim 1, further comprising:
a second semiconductor layer comprising a second layout pattern,
wherein the check circuit calculates the second layout pattern and the first dummy pattern to generate a third calculated value and compares the third calculated value to a third predetermined value to determine whether the second layout pattern has been modified.

10. The semiconductor layout as claimed in claim 9, wherein the second layout pattern does not overlap the first layout pattern.

11. The semiconductor layout as claimed in claim 1, wherein the check circuit compares the first layout pattern to a second layout pattern to determine whether the first layout pattern is the same as the second layout pattern.

12. The semiconductor layout as claimed in claim 11, wherein in response to there being a difference between the first layout pattern and the second layout pattern, the check circuit records the location of the difference.

13. A method for checking a semiconductor layout, comprising:
forming a first layout pattern in a first semiconductor layer;
forming a first dummy pattern in a first dummy layer;
performing a Boolean operation to calculate the first layout pattern and the first dummy pattern to generate a first calculated value; and
comparing the first calculated value and a first predetermined value,
wherein in response to the first calculated value not being equal to the first predetermined value, it is determined that the first layout pattern has been modified.

14. The method as claimed in claim 13, further comprising:
recording the location of the first layout pattern in response to the first calculated value not being equal to the first predetermined value.

15. The method as claimed in claim 13, wherein the Boolean operation is a AND operation, an OR operation, or a XOR operation.

16. The method as claimed in claim 13, further comprising:
forming a second dummy pattern in a second dummy layer;
performing the Boolean operation to calculate the first layout pattern and the second dummy pattern to generate a second calculated value;
comparing the second calculated value to a second predetermined value,
wherein in response to the first calculated value being equal to the first predetermined value and the second calculated value not being equal to the second predetermined value, it is determines that the first layout pattern has been modified.

17. The method as claimed in claim 16, wherein the first dummy pattern is different from the second dummy pattern.

18. The method as claimed in claim 13, further comprising:
forming a second layout pattern in a second semiconductor layer;
performing the Boolean operation to calculate the second layout pattern and the first dummy pattern to generate a third calculated value; and
comparing the third calculated value to a third predetermined value to determine whether the second layout pattern has been modified.

19. The method as claimed in claim 13, further comprising:
comparing the first layout pattern to the second layout pattern to determine whether the first layout pattern is the same as the second layout pattern,
wherein the second layout pattern is disposed in a second semiconductor layer which is different from the first semiconductor layer.

20. The method as claimed in claim 19, wherein in response to there being a difference between the first layout pattern and the second layout pattern, the location of the difference is recorded.
